(19) United States
(12) Patent Application Publication
(10) Pub. No.: US 2024/0347912 A1
(43) Pub. Date: Oct. 17, 2024

(54) ANTENNA AND METHOD FOR MANUFACTURING AN ANTENNA

(71) Applicant: Schaffner EMV AG, Luterbach (CH)

(72) Inventors: Roberto Mrad, Zuchwil (CH); Philippe Fuchs, Pfastatt (FR)

(73) Assignee: Schaffner EMV AG, Luterbach (CH)

(21) Appl. No.: 18/612,895

(22) Filed: Mar. 21, 2024

(30) Foreign Application Priority Data
Apr. 13, 2023 (EP) 23167820.2

(51) Int. Cl. H01Q 7/08; H01Q 1/32

(52) U.S. Cl. CPC H01Q 7/08; H01Q 1/3241

(57) ABSTRACT

According to the present invention there is provide an antenna comprising a core, and a coil, wherein the core comprises a plurality of magnetic bricks, characterized in that each of the magnetic bricks have at least one convex surface. There is further provided a method of manufacturing said antenna.

### FIELD OF THE INVENTION

The present invention concerns an antenna and in particularly an antenna which has a core formed of a plurality of magnetic bricks; wherein each of the magnetic bricks have a convex surface. The is further provided a corresponding method for manufacturing said antenna.

### BACKGROUND TO THE INVENTION

Antennas generally consist of a core and a coil. Depending on the range of coverage and transmission frequency and the band width, the core and the coil must be correspondingly designed. The band widths of antennas are becoming ever wider, for example for UWB antennas, and the coverage range of antennas is becoming ever greater (i.e. antennas are required to provide a high level of field strength over a larger distance range around the antenna), which has the consequence, for example, that the cores of antennas are becoming ever longer. However, long cores, which are formed by a single core unit, are also more liable to rupture than short cores and are more difficult to produce.

It has therefore become known in the meantime to form the core of the antenna from a plurality of partial cores (magnetic bricks) arranged one behind the other, for example in U.S. Ser. No. 10/056,687, EP1397845, US2018159224. Having a core formed of a plurality of partial cores (magnetic bricks) has the advantage that the individual partial cores (magnetic bricks) are easier to produce and the core will be less liable to rupture.

However, while these existing cores formed of a plurality of partial cores (magnetic bricks) offer advantages over long core, they are not without drawbacks. In particular, because the partial cores (magnetic bricks) used are cuboid-shaped/rectangular rod-shaped, if the core/antenna is bent then varying sized gaps will appear between the partial cores; these gaps compromise the performance of the antenna. In particular, since the partial cores (magnetic bricks) are cuboid-shaped/rectangular rod-shaped the partial cores abut one another so that there is little or no gap between the partial cores (magnetic bricks) which form the core of the antenna; any gap which may subsequently form between the partial cores (magnetic bricks) will result in a large change in the effective permeability of the core. Gaps may form between the partial cores (magnetic bricks) (e.g. due to heating of a potting compound which surrounds the partial cores (magnetic bricks), or due to mechanical bending of the antenna). Large changes change in the effective permeability of the core is undesirable because it results in large variations in the inductance of the core.

Furthermore, in these existing cores it is difficult to ensure a regular spacing between the partial cores (magnetic bricks); very often the spacing between the partial cores (magnetic bricks) in a core of an antenna, will vary; these variations in the spacing may lead to a variation in the inductance of the core of that antenna. Moreover, the variations in spacing between the partial cores (magnetic bricks) in a core may lead to spacings between the partial cores (magnetic bricks) in one core of an antenna differing from the spacings between the partial cores (magnetic bricks) in a core of another antenna of the same type; these differences in spacing between the partial cores may lead to a variation in the inductance of cores of antenna of the same type.

It is an aim of the present invention the mitigate or obviate at least some of the disadvantages associated with the prior art.

### SUMMARY OF THE INVENTION

It is an aim of the present invention to provide an antenna which has a core that undergoes less magnitude of variations in the effective permeability when the antenna is in use or undergo mechanical deformation.

This aim is achieved according to the invention in the case of an antenna and a production process for such an antenna according to the independent claims.

In the present invention the core comprises a plurality of magnetic bricks which have a convex surface. Advantageously the convex surfaces ensure that there are gaps between the surfaces of the magnetic bricks which form the core. These gaps ensure that when the gaps increase) (e.g. due to heating of a potting compound which surrounds the magnetic bricks, or due to mechanical bending of the antenna) the magnitude of change in the permeability of the core will be less than the magnitude of change in the permeability of the core that would occur if there were initially no gaps between the surfaces of the magnetic bricks. Consequently, the core will have less variance in its inductance, leading to improved and more stable performance of the antenna.

It should be understood that in the present application where there is a ‘gap’ between surfaces this can mean that the surfaces do not touch/abut each other over the whole of their respective surface areas; or, that the surfaces do not touch/abut each other only at a part/a portion of the their respective surfaces areas (i.e. that a portion of surfaces touch/abut each other over only a part of their respective surface areas (e.g. at an apex) and do touch/abut each other the rest of the respective surface areas).

### BRIEF DESCRIPTION OF THE DRAWINGS

Exemplary embodiments of the invention are disclosed in the description and illustrated by the drawings in which:

FIG. 1a provides a perspective view of an antenna according to an embodiment of the present invention; FIG. 1b provides a longitudinal section view of said antenna; FIG. 1c provides a side view of said antenna; FIG. 1d provides a magnified view of a portion of the longitudinal section view of FIG. 1b.

FIG. 2a provides a perspective view of a magnetic brick used in the antenna of FIG. 1a; FIG. 2b is a side view of said magnetic brick.

### DETAILED DESCRIPTION OF EMBODIMENTS OF THE INVENTION

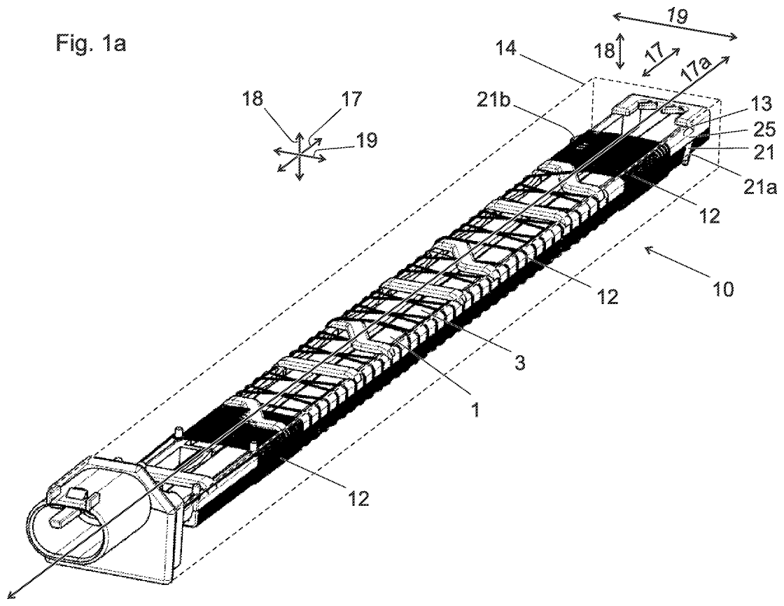

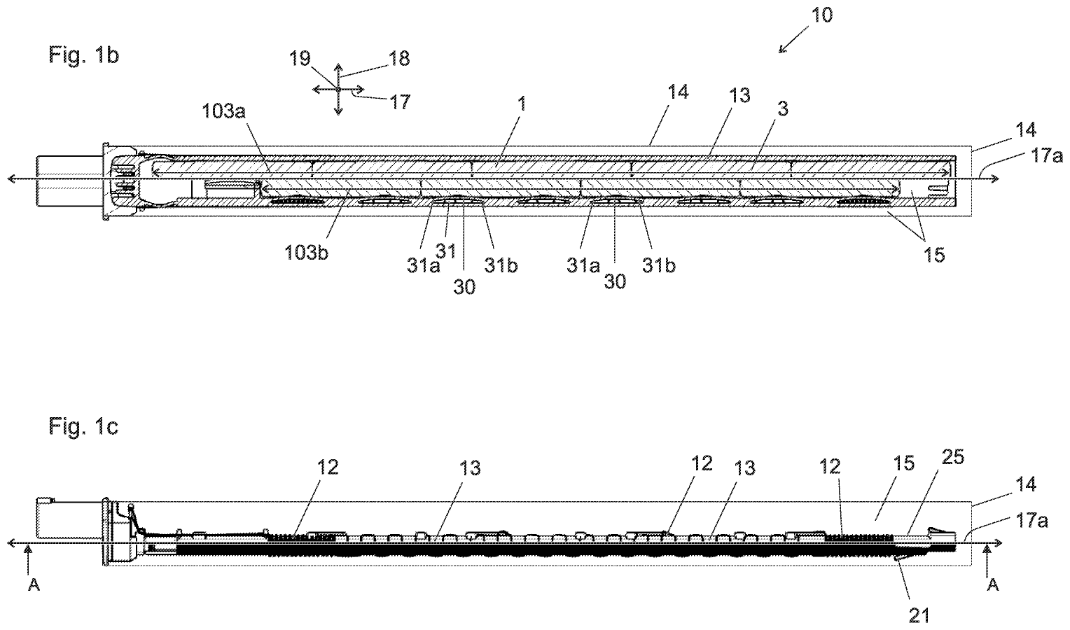

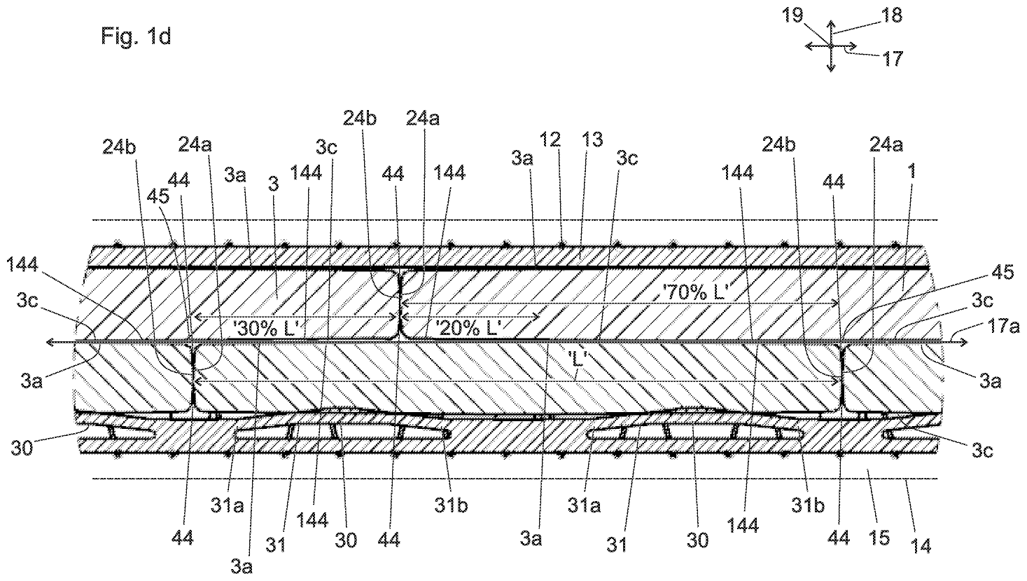

Referring to FIGS. 1a-1d, in which FIG. 1a provides a perspective view of an antenna 10 according to an embodiment of the present invention; FIG. 1b provides a longitudinal section view of said antenna 10; FIG. 1c provides a side view of said antenna 10; and FIG. 1d provides a magnified view of a portion of the longitudinal section view of FIG. 1b.

The antenna 10 comprises a core 1 and a coil 12. The antenna preferably also has a housing 14, a core support 13 and a potting compound 15.

The core 1 is a magnetic core 1. The core 1 is made of a magnetic material. Magnetic material means that the material is paramagnetic or ferromagnetic, preferably ferromagnetic. The core 1 is preferably made of a ferrite material (ferrite material) or a powder material (powder core). The core 1 is preferably made of a rigid magnetic material.

The core 1 preferably extends along the first direction 17. The first direction is therefore also referred to as the longitudinal direction 17 of the core 1. A longitudinal axis 17a of the core 1 consequently extends in the first direction 17. The core 1 is preferably longer in the longitudinal direction 17 than in a second direction 18 orthogonal to the longitudinal direction 17 and longer in the longitudinal direction 17 than in a third direction 19 orthogonal to the longitudinal direction 17. In an exemplary embodiment, the core 1 is larger in the second direction 18 (thickness or height) than in the third direction 19 (width). In another exemplary embodiment, the core 1 is of the same size in the second direction 18 and in the third direction 19.

The core 1 is held within the core support 13; and the coil 12 is wound around said core support 13. The core support 13 containing the core 1 and the coil 12 wound around the core support 13, are all positioned within the housing 14; and preferably some (or all) of the remaining volume within the housing is filled with a potting compound 15 (i.e. the potting compound preferably partially fills the remaining volume within the housing, or, completely fills the remaining volume within the housing). Preferably the potting compound will move under the influence of gravity towards an end of the housing. The potting compound 15 may be softer than 60 Shore A, and preferably is softer than 40 Shore A. It should be understood that in the present invention a foam compound can be used instead of a potting compound.

The housing 14 preferably has an opening which is designed for receiving the core support 13 containing the core 1 and the coil 12 wound around the core support 13, into the housing 14. The opening is preferably closed by the core support 13 in the inserted state. Preferably the core support comprises a cap member which is integral to the core support 13 (e.g. core support 13 and cap member may be a single unit), and the cap member closes the opening in the housing when the core support 13 is in the inserted state. A connector which forms a part of the core support 13, and to which the coil 12 may be electrically connected, may define the cap member which closes the opening in the housing when the core support 13 is in the inserted state. In another embodiment the cap member is mechanically independent of the core support 13; and after the core support 13 has been inserted into the hosing 14 the cap member is positioned to close the opening in the housing 14. Thus also it is possible that the opening is closed by a separate cover or cap member. The core support 13 and/or cap member may comprise any suitable material; for example, the core support 13 and/or cap member may comprise plastic. Preferably when the cap member is integral to the core support 13 the cap member and core support 13 are formed of the same material.

The core support 13 comprises two or more outer spring members 21 which project, in opposite directions, from an outer surface 25 of the core support 13. In this embodiment the core support 13 comprises a first outer spring member 21a projects from one side of the core support 13 and a second outer spring member 21b projects from a second opposite side of the core support 13. When the core support 13 is being positioned into the housing 14 the spring members 21a,b are forced to compress by the inner walls of the housing 14; the compressed spring members 21a,b help to reduce the movement of the core support 13 within the housing 14. The spring members 21a,b will also help aligning the core support 13 into a predefined position within the housing 14; for example, the spring members 21a,b will help to centre the core support 13 in the housing. Centering the core support 13 in the housing will ensure that the potting compound 15 around the core support 13 will have a substantially constant thickness. When the potting compound 15 around the core support 13 has a substantially constant thickness the potting compound can provide an optimum damping of mechanical shocks applied to the antenna 1.

Importantly, in the antenna 10 the core 1 comprises a plurality of magnetic bricks 3. Each of the magnetic bricks 3 have a convex surface 3a,3b,3c,3d,4a,4b. Each magnetic brick 3 is orientated to be parallel to the longitudinal axis 17a of the core 1.

Each of the magnetic bricks 3 which make up the core 1 is made of a magnetic material. Magnetic material means that the material is paramagnetic or ferromagnetic, preferably ferromagnetic. Each of the magnetic bricks 3 which make up the core 1 is preferably made of a ferrite material (ferrite material) or a powder material (powder core). Each of the magnetic bricks 3 which make up the core 1 is preferably made of a rigid magnetic material.

The magnetic material of the core 1, corresponds to the magnetic material of the magnetic bricks 3. In this case, all of the magnetic bricks 3 preferably have the same magnetic material. However, it is also possible to use different magnetic materials in different the magnetic bricks 3.

As mentioned, the plurality of magnetic bricks 3 are held in said core support 13. The core support 13 further comprise a plurality of inner spring members 30 each of which project into a volume defined by the core support 13. The inner spring members 30 apply a force to the magnetic bricks 3 that are located in said volume defined by the core support 13. The inner spring members 30 may take any suitable form; in the present embodiment the each of the inner spring members 30 comprise a flexible bow-shaped member 31 which is connected at opposite ends 31a,31b to an inner wall of the core support 13. When the magnetic bricks 3 are packed into the core support 13 the magnetic bricks 3 apply a force to the flexible bow-shaped members 31 which compresses the flexible bow-shaped members 31; in turn the compressed flexible bow-shaped members 31 apply a counter force to the magnetic bricks 3 and this counter force helps to reduce the movement of the magnetic bricks 3 within the core support 13. Furthermore, the inner spring members 30 can help to reduce inertia of the magnetic bricks 3 when a mechanical shock is imparted on the antenna 10. Furthermore the inner spring members 30 can also provide some suspension and/or damping to the core 1 so that when a mechanical shock is imparted on the antenna the inner spring members 30 will absorb some/all of the energy of the mechanical shock thereby preventing all of the energy from the mechanical sock from being transmitted to the brick members 3 in the core 1, thus protecting the brick members 3 in the core 1 from damage.

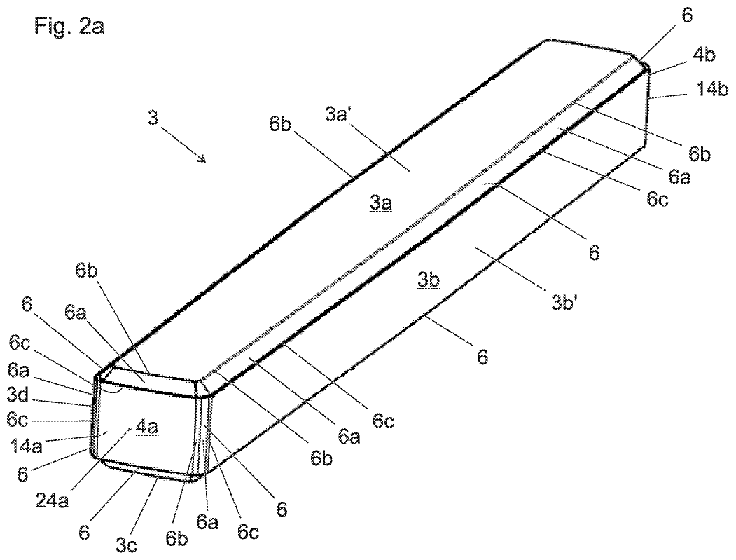

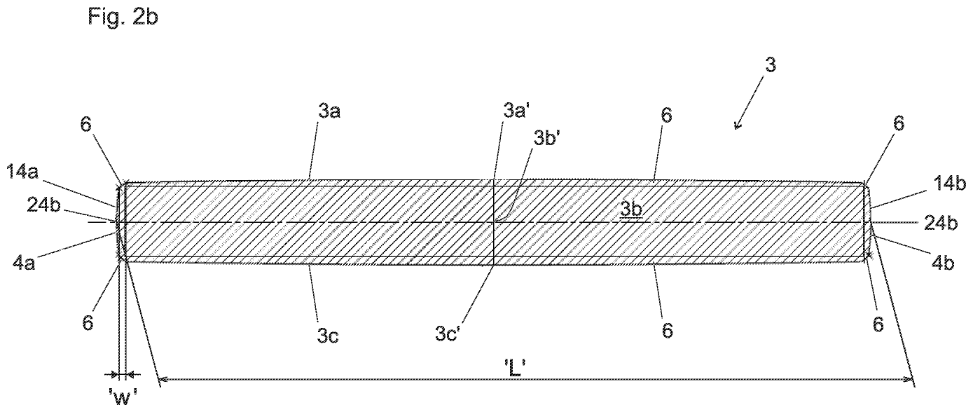

FIGS. 2a and 2b illustrate the shape of each of the magnetic bricks 3. Most preferably all of the magnetic bricks 3 in the antenna 10 have the same shape. In this example each of the magnetic bricks 3 in the antenna 10 are substantially barrel-shaped. Specifically, each magnetic brick comprises a first end 14a and a second, opposite end 14b—the first end 14a is defined by a first end surface 4a and the second opposite end 14b is defined by a second end surface 4b. In this embodiment the first end surface 4a and the second end surface 4b are both convex shaped. Because the first end surface 4a and the second end surface 4b are both convex shaped, the first end surface 4a will have a first apex 24a and the second end surface 4b will have a second apex 24b. Most preferably the dimensions and profile of the first end surface 4a and the second end surface 4b are the equal. Preferably the height of the arc of the convex first end surface 4a and height of the arc of the convex second end surface 4b is each in the range 0.03 cm-0.07 cm, and is preferably 0.05 cm. While in this embodiment the first end surface 4a and the second end surface 4b are convex shaped, it should be understood that the first end surface 4a and the second end surface 4b could have any other suitable profile; for example, in another preferred embodiment, the first end surface 4a and the second end surface 4b are each flat.

Each magnetic brick 3 preferably has a length ‘L’ that is between 2 cm-8 cm, more preferably between 4 cm-5 cm (i.e. the distance between the first apex 24a of the first end surface 4a and the second apex 24b of the second end surface 4b, is between 2 cm-8 cm, and more preferably between 4 cm-5 cm). Most preferably the length ‘L’ of each magnetic brick is 4.5 cm.

Each magnetic brick 3 has a four longitudinal surfaces 3a,3b,3c, 3d each of which extend, substantially, between the first end 14a of the magnetic brick 3 and the second, opposite end 14b of the magnetic brick 3.

In the embodiment shown in the figures, for each magnetic brick 3 the longitudinal surface 3a,3c which is facing another magnetic brick 3 is convex and the longitudinal surface 3a,3c which is opposite to the longitudinal surface 3a,3c which is facing said other magnetic brick 3 is convex; and the other two opposing longitudinal surfaces 3b,3d of the magnetic brick 3 are flat (and preferably the first end surface 4a and the second end surface 4b may be each flat or convex). In other words in the embodiment shown in the figures only two of the longitudinal surfaces 3a,3c of each respective magnetic brick 3 are convex, and preferably the longitudinal surfaces 3a,3c which are convex are opposite surfaces of the magnetic brick 3; and the other longitudinal surfaces 3b, 3d of said respective magnetic brick 3 are flat (and preferably the first end surface 4a and the second end surface 4b may be each flat or convex).

The convex longitudinal surfaces 3a,3c will each have a respective apex 3a′,3c′. Preferably the height of the arc of each convex longitudinal surface 3a,3c is in the range 0.08 mm-0.12 mm, and is preferably 0.1 mm. In an embodiment a radius of the arc of each convex longitudinal surface 3a,3c is in the range 20 cm-30 cm, and is preferably 25 cm.

It should be understood that in the present application when a surface is said to be convex, it does not require that the entire surface area of that surface be convex; it is sufficient that only a portion of the surface area of the surface is convex. So, for example, the longitudinal surfaces 3a,3c of the magnetic bricks 3 are said to be convex, this can mean that the whole of the respective surface areas of the respective longitudinal surfaces 3a,3c have a convex profile, or, that only a portion of the respective surface areas of the respective longitudinal surfaces 3a,3c have a convex profile.

In an embodiment only the longitudinal surface 3a which is facing another magnetic brick 3 is convex; and all of the other longitudinal surfaces 3b,3c, 3d of the magnetic brick 3 are flat (and the first end surface 4a and the second end surface 4b may be each flat or convex). In other words in an embodiment only one of the longitudinal surfaces 3a of each respective magnetic brick 3 is convex and the other longitudinal surfaces 3b,3c, 3d of said respective magnetic brick 3 are flat (and preferably the first end surface 4a and the second end surface 4b may be each flat or convex).

In another embodiment, each of the longitudinal surfaces 3a,3b,3c, 3d are convex. Since each of these longitudinal surfaces 3a,3b,3c, 3d are convex they will each have a respective apex 3a′,3b′,3c′,3d′. Preferably the height of the arc of each convex longitudinal surface 3a,3b,3c, 3d is in the range 0.08 mm-0.12 mm, and is preferably 0.1 mm. In an embodiment a radius of the arc of each convex longitudinal surface 3a,3b,3c, 3d is in the range 20 cm-30 cm, and is preferably 25 cm. These longitudinal surfaces 3a,3b,3c, 3d define the vast majority of the outer surface of the magnetic brick 3 that is between the first end 14a and second end 14b. If all of the longitudinal surfaces 3a,3b,3c, 3d are convex then almost the whole outer surface of the magnetic brick 3, between the first end 14a and second end 14b of the brick, will be convex.

In the embodiment shown in the figures, in each magnetic brick 3 a respective intermediate surface portions 6 connect adjacent longitudinal surfaces 3a,3b,3c, 3d; similarly respective intermediate surface portions 6 connects one respective end of each longitudinal surface 3a,3b,3c, 3d to the first end surface 4a, and, respective intermediate surface portions 6 connect the respective opposite end of each longitudinal surface 3a,3b,3c, 3d to the second end surface 4a. In this example each of the intermediate surface portions 6 comprises a flat section 6a, and first curved section 6b on one side of the flat section and a second curved section 6c on an opposite side of the flat section 6a; in this example each of the first curved section 6a and the second curved section 6b each have a convex profile. In this example each of the intermediate surface portions 6 has a total width ‘w’ between 0.5 mm-0.9 mm, and preferably has a total width ‘w’ of 0.75 mm. Preferably the height of the arc of each of the first and second curved sections 6a,6b is between 0.3 mm-0.5 mm; most preferably the height of the arc of each of the first and second curved sections 6a,6b is 0.45 mm. In this example each of flat section 6a of each intermediate surface portion 6 is preferably arranged at a substantially 45° with respect to the longitudinal surface 3a,3b,3c, 3d to which the intermediate surface portions 6 connected.

However it should be understood that the intermediate surface portions 6 could have any other suitable profile, for example, the intermediate surface portions 6 could each have convex profile. If the intermediate surface portions 6 have convex profile then the overall shape of the magnetic brick 3 would be more rounded-barrel-shaped. It should be understood that the intermediate surface portions 6 are not essential to the present invention; in another embodiment the magnetic bricks 3 have no intermediate surface portions 6, in which case adjacent longitudinal surfaces 3a,3b,3c, 3d connect directly to one another and the respective opposite ends of each longitudinal surface 3a,3b,3c, 3d connects directly to respective first and second end surfaces 4a,4b.

It should be understood that in the present invention the magnetic bricks 3 could have any suitable shape so long as each brick have at least one convex surface. For example, in another embodiment each of each of the magnetic bricks may be rounded barrel-shaped, in which case each magnetic brick would have no intermediate surface portions 6, rather the whole outer surface of the magnetic brick that is between the first end surface 4a and the second end surface 4b would be convex. In another example each magnetic brick may be substantially cuboid shape and have just one or more longitudinal surfaces which are convex; for example, each magnetic brick may be substantially cuboid shape but having only two, opposite, longitudinal surfaces which are convex (and the two other longitudinal surfaces having a flat profile). In another example, each magnetic brick may be substantially cuboid shape but having four longitudinal surfaces each which are convex. In another example, each magnetic brick may be substantially cuboid shape but having just one single longitudinal surface that is convex (and the three other longitudinal surfaces having a flat profile). In another embodiment each magnetic brick may be substantially cuboid shape (e.g. substantially rectangular prism) wherein the four longitudinal surfaces each have a flat profile, and only the first end surface 4a and/or the second end surface are convex.

It should also be understood that while in the preferred embodiment all of the magnetic bricks 3 in the antenna 10 have the same shape, in other embodiment(s) the antenna 10 may comprise magnetic bricks which have two or more different shapes. For example in another embodiment the antenna 10 may comprise a core 1 which comprises some magnetic bricks 3 which are substantially barrel shaped, as shown in FIGS. 2a,2b, and some other magnetic bricks which are cuboid shaped (e.g. wherein all the surfaces of the magnetic brick are flat) or are substantially cuboid shaped (e.g. wherein at least the four longitudinal surfaces are flat and the first and/or second end surfaces may be convex). The cuboid shaped, or are substantially cuboid shaped, magnetic bricks, may be arranged to surround the substantially barrel shaped magnetic bricks 3 so that the surface of the cuboid shaped magnetic bricks define an outer surface of the core 1; this will ensure that the outer surface of the core 1 is substantially flat. Having a core 1 with a flat outer surface may be useful for some applications; for example, it may allow the core 11 to better fit inside some types of core supports.

Referring back to FIGS. 1a-d it can be seen that the core 1 of the assembly 10 comprises, a first series 103a of magnetic bricks 3 which are arranged one behind the other in a direction of the longitudinal axis 17a of the core 1; and a second series 103b of magnetic bricks 3 which are arranged one behind the other in a direction of a longitudinal axis 17a of the core 1. The first series 103a and second series 103b are adjacent to one another. The magnetic bricks 3 in the first series 103a and the magnetic bricks 3 in the second series 103b are positioned on the same plane.

As mentioned, in the exemplary embodiment shown in the figures, the longitudinal surface 3a,3c of a respective magnetic brick 3, which is facing another magnetic brick 3, is convex, and the longitudinal surface 3a,3c of said respective magnetic brick 3 which is opposite to the longitudinal surface 3a which is facing said other magnetic brick 3 is also convex; and the other two longitudinal surfaces 3b, 3d of said respective magnetic brick 3 are flat (and preferably the first end surface 4a and the second end surface 4b may be each flat or convex). In other words in the exemplary embodiment shown in the figures only two of the longitudinal surfaces 3a,3c of each respective magnetic brick 3 are convex, and the other longitudinal surfaces 3b, 3d are flat (and preferably the first end surface 4a and the second end surface 4b may be each flat or convex).

So, referring to FIG. 1d, the two, opposite facing longitudinal surfaces 3c and 3a of each respective magnetic brick 3 in the first series 103a are convex, while the other two longitudinal surfaces 3b,3d of each respective magnetic brick 3 in the first series 103a are flat; and the two, opposite facing longitudinal surfaces 3a and 3c of each respective magnetic brick 3 in the second series 103b are convex, while the other two longitudinal surfaces 3b,3d of each respective magnetic brick 3 in the second series 103b are flat. In the first series 103a, the longitudinal surface 3c of each respective magnetic brick 3 is facing a magnetic brick 3 in the second series 103b, and therefore is convex; and the longitudinal surface 3a is opposite to the longitudinal surface 3c and therefore is also convex. In the second series 103b, the longitudinal surface 3a of each respective magnetic brick 3 is facing a magnetic brick 3 in the first series 103a, and therefore is convex; and the longitudinal surface 3a is opposite to the longitudinal surface 3c and therefore is also convex. The first end surface 4a and the second end surface 4b of each respective magnetic brick 3 in the first and second series 103a,103b may be each flat or convex.

In this embodiment the magnetic bricks 3 in the first series 103a and the magnetic bricks 3 second series 103b are arranged so that the first end surface 4a of a magnetic brick 3 abuts the second end surface 4b of the preceding magnetic brick 3 in the series and the second end surface 4b abut the first end surface 4a of the next magnetic brick 3 in the series (expect for the first and last magnetic bricks 3 in the series). Specifically, in this embodiment the magnetic bricks 3 in the first series are arranged so that the first end surface 4a of a magnetic brick 3 abuts the second end surface 4b of the preceding magnetic brick 3 in the first series and the second end surface 4b abuts the first end surface 4a of the next magnetic brick 3 in the first series (expect for the first and last magnetic bricks in the first series; for the very first magnetic brick in the first series only its second end surface 4b abuts the first end surface 4a of the second magnetic brick 3 in the first series, while its first end surface 4a is not abutting any adjacent magnetic brick 3; and for the last magnetic brick in the first series only its first end surface 4a abuts the second end surface 4b of the preceding magnetic brick 3 in the first series, while its second end surface 4b is not abutting any adjacent magnetic brick). The magnetic bricks 3 in the second series are arranged so that the first end surface 4a of a magnetic brick 3 abuts the second end surface 4b of the preceding magnetic brick 3 in the second series and the second end surface 4b abut the first end surface 4a of the next magnetic brick 3 in the second series (expect for the first and last magnetic bricks in the second series; for the very first magnetic brick in the second series only its second end surface 4b abuts the first end surface 4a of the second magnetic brick 3 in the second series, while its first end surface is not abutting any adjacent magnetic brick; and for the last magnetic brick in the second series only its first end surface 4a abuts the second end surface 4b of the preceding magnetic brick 3 in the second series, while its second end surface 4b is not abutting any adjacent magnetic brick).

In this embodiment, since the first end surface 4a and the second end surface 4b of each of the magnetic bricks 3 are convex, in each of the first and second series, adjacent magnetic bricks that abut each other will not contact one another over the whole area of their respective end surfaces 4a,4b; in other words, in each of the first and second series, only the apex 24a of the first end surface 4a of a magnetic brick abuts the apex 24b of the second end surface 4b of the preceding magnetic brick 3, and there will be a gap 44 (as can be best see in FIG. 1d) between the rest of said first end surface 4a and second end surface 4b.

The magnetic bricks 3 in the first series 130a are offset from the magnetic bricks 3 in the second series 103b, and vice versa.

As can be best seen in FIG. 1d, the magnetic bricks in the first and second series 103a,103b are arranged so that a respective portion 45 of a convex longitudinal surface 3c surface of each respective magnetic brick 3 in the first series 103a is aligned with a respective gap 44 in the second series 103b, and a respective portion 45 of a convex longitudinal surface 3a of each respective magnetic brick 3 in the second series 103a is aligned with a respective gap 44 in the first series 103a. In other words the respective portion 45 of the convex longitudinal surface 3c of each respective magnetic brick 3 in the first series 103a is aligned with where adjacent magnetic bricks 3 in the second series abut one another; and the respective portion 45 of the convex longitudinal surface 3a of each respective magnetic brick 3 in the second series 103b is aligned with where adjacent magnetic bricks 3 in the first series abut one another.

Importantly it is not essential that the apex 3a′,3c′ of the convex longitudinal surface 3a3c be aligned with the respective gap 44; in other words it is not essential that the respective portion 45 be the apex 3a′, 3c′ of the convex longitudinal surface 3a3c, or that the respective portion 45 contain the apex 3a′,3c′ of the convex longitudinal surface 3a,3c. In fact, preferably the magnetic bricks are arranged so that the apex 3a′,3c′ of the convex longitudinal surface 3a,3c is off-set from the respective gap 44.

In the present embodiment the magnetic bricks 3 in the first and second series 103a,103b are arranged so that the longitudinal surface 3a,3b,3c,3d of each magnetic brick 3 in the first series 103a (expect for the first and last magnetic brick 3 in the first series) is opposite and adjacent to (e.g. extends over) 30% of the length ‘L’ of one magnetic brick 3 in the second series 103b and also is opposite and adjacent to (e.g. extends over) 70% of a length ‘L’ of another magnetic brick 3 in the second series 103b (In the present exemplary embodiment since the first series 103a is longer than the second series 103b (i.e. there are more magnetic bricks 3 in the first series 103a than in the second series 103b) the first magnetic brick 3 in the first series 103a is opposite and adjacent to (e.g. extends over) only 30% of the length of one magnetic brick 3 in the second series 103b; and the last magnetic brick 3 in the first series 103a is opposite and adjacent to (e.g. extends over) only 70% of the length of one magnetic brick 3 in the second series 103b); and each magnetic brick 3 in the second series 103b is opposite and adjacent to (e.g. extends over) 30% of the length ‘L’ of one magnetic brick 3 in the first series 103a and also is opposite and adjacent to (e.g. extends over) 70% of a length ‘L’ of another magnetic brick 3 in the first series 103a. This means that for each magnetic brick 3 in the first series 103a (expect for the first and/or last magnetic brick 3 in the first series) the apex 3a′ of the convex longitudinal surface 3a of the magnetic brick 3 will be aligned with a point which is located at 20% along the length ‘L’ of a magnetic brick 3 in the second series 103b; and for each magnetic brick 3 in the second series 103b the apex 3a′ of the convex longitudinal surface 3a of the magnetic brick 3 will be aligned with a point which is located at 20% along the length ‘L’ of a magnetic brick 3 in the first series 103a.

It is not essential that there are more magnetic bricks 3 in the first series 103a than in the second series 103b; the number of bricks in first and second series 103a,103b is preferably dependent on the field requirements of the antenna. The number of magnetic bricks 3 in the first series 103a and the second series 103b may be equal, or, the number of magnetic bricks 3 in the first series 103a may be greater than the number of magnetic bricks 3 in the second series 103b, or, the number of magnetic bricks 3 in the second series 103b may be greater than the number of magnetic bricks 3 in the first series 103a.

Preferably each of the respective magnetic bricks 3 in the first series 103a are the same as (i.e. have the same shape and dimensions as) the respective magnetic bricks 3 in second series 103b. However in another embodiment the magnetic bricks 3 in the first series 103a are different to (i.e. have different shape and/or dimensions to) the magnetic bricks 3 in second series 103b; for example each of the magnetic bricks 3 in the first series 103a may have no convex surfaces (e.g. all of the longitudinal surfaces 3a,3b,3c,3d of each magnetic brick 3 in the first series 103a, may be flat), while each of the magnetic bricks 3 in second series 103b may have two, opposite facing longitudinal surfaces 3c and 3a which are convex, and the other two longitudinal surfaces 3b,3d being flat; or in another example each of the magnetic bricks 3 in the second series 103b may have no convex surfaces (e.g. all of the longitudinal surfaces 3a,3b,3c,3d of each magnetic brick 3 in the second series 103b, may be flat), while each of the magnetic bricks 3 in first series 103a may have two, opposite facing longitudinal surfaces 3c and 3a which are convex, and the other two longitudinal surfaces 3b,3d being flat.

It is not essential that the magnetic bricks 3 are arranged so that the apex 3a′,3c′ of the convex longitudinal surface 3a,3c be off-set from the respective gap 44. In another embodiment the magnetic bricks 3 in the first and second series 103a,103b are arranged so that the longitudinal surface 3a,3b,3c,3d of each magnetic brick 3 in the first series 103a (expect for the first and last magnetic brick 3 in the first series 103a) is opposite and adjacent to (e.g. extends over) 50% of the length ‘L’ of one magnetic brick 3 in the second series 103b and also is opposite and adjacent to (e.g. extends over) 50% of a length ‘L’ of another magnetic brick 3 in the second series 103b; and each magnetic brick 3 in the second series 103b is opposite and adjacent to (e.g. extends over) 50% of the length ‘L’ of one magnetic brick 3 in the first series 103a and also is opposite and adjacent to (e.g. extends over) 50% of a length ‘L’ of another magnetic brick 3 in the first series 103a. This arrangement will ensure that the apex 3c′ of the convex longitudinal surface 3c, of each magnetic brick 3 in the first series 103a will be aligned with a respective gap 44 in the second series 103b; and the apex 3a′ of the convex longitudinal surface 3a, of each magnetic brick 3 in the second series 103b will be aligned with a respective gap 44 in the first series 103a.

It should be understood that magnetic brick 3 could be arranged in any suitable arrangement. Preferably, the magnetic bricks 3 in the first and second series 103a,103b are arranged so that the longitudinal surface 3a,3b,3c,3d of each magnetic brick 3 in the first series 103a (expect for the first and last magnetic brick 3 in the first series 103a) is opposite and adjacent to (e.g. extends over) between 10%-50% of the length ‘L’ of one magnetic brick 3 in the second series 103b and also is opposite and adjacent to (e.g. extends over) between 50%-90% of a length ‘L’ of another magnetic brick 3 in the second series 103b; and each magnetic brick 3 in the second series 103b is opposite and adjacent to (e.g. extends over) between 10%-50% of the length ‘L’ of one magnetic brick 3 in the first series 103a and also is opposite and adjacent to (e.g. extends over) between 50%-90% of a length ‘L’ of another magnetic brick 3 in the first series 103a.

As described, in the present embodiment of the antenna 10, a longitudinal surface 3a,3b,3c,3d of each magnetic brick 3 in the second series 103b is opposite and adjacent to (e.g. extends over) respective portions of longitudinal surfaces 3a,3b,3c,3d of two magnetic bricks 3 in the first series 103a; and a longitudinal surface 3a,3b,3c,3d of each magnetic brick 3 in the first series 103a is opposite and adjacent to (e.g. extends over) respective portions of longitudinal surfaces 3a,3b,3c,3d of two magnetic bricks 3 in the second series 103b (except for maybe the first and/or last magnetic brick in the first series 103a; a longitudinal surface 3a,3b,3c,3d of the first magnetic brick 3 in the first series 103a may be opposite and adjacent to (e.g. extends over) a portion of a longitudinal surface 3a,3b,3c,3d of only one magnetic brick 3 in the second series 103b, and/or, a longitudinal surface 3a,3b,3c,3d of the last magnetic brick 3 in the first series 103a may be opposite and adjacent to (e.g. extends over) a portion of a longitudinal surface 3a,3b,3c,3d of only one magnetic brick 3 in the second series 103b). The apex 3a′ of the longitudinal surface 3a of each magnetic brick 3 in the second series 103b will abut a longitudinal surface 3c of one magnetic brick 3 in the first series 103a. The apex 3c′ of the longitudinal surface 3a of each magnetic brick 3 in the first series 103a will abut a longitudinal surface 3c of one magnetic brick 3 in the second series 103b (except for maybe the first and/or last magnetic brick 3 in the first series 103a in this embodiment wherein the first series 103a contains more magnetic bricks 3 than the second series 103b; as can be seen in FIG. 1b the apex 3c′ of a longitudinal surface 3c of the first magnetic brick 3 in the first series 103a does not abut any other brick).

Importantly, since the longitudinal surfaces 3c of each of the magnetic bricks 3 in the first series 103a are convex and the longitudinal surfaces 3a of each of the magnetic bricks 3 in the second series 103b are convex, longitudinal surfaces 3a 3c which are opposite and adjacent (e.g. extends over) one another will not contact one another over the whole of their respective surface areas; in other words, for each magnetic brick 3 in each of the first series 103a only the apex 3c′ of the longitudinal surface 3c of that magnetic brick 3 will abut another magnetic brick 3 in the second series 103b, and there will be a gap 144 (as can be best see in FIG. 1d) between the rest of the longitudinal surface 3c of that magnetic brick 3 and the longitudinal surface 3a belonging to said other magnetic brick 3 in the second series 103b, that is opposite and adjacent to it; and for each magnetic brick 3 in the second series 103b, only the apex 3a′ of the longitudinal surface 3a of that magnetic brick 3 will abut another magnetic brick 3 in the first series 103a, and there will be a gap 144 (as can be best see in FIG. 1d) between the rest of the longitudinal surface 3a of that magnetic brick 3 and the longitudinal surface 3c belonging to said other magnetic brick 3 in the first series 103a that is opposite and adjacent to it.

Advantageously the convex profile of the longitudinal surfaces 3a 3c and/or the convex profile of the end surfaces 4a,4b, ensure that there are gaps 144,44 between the magnetic bricks 3 which form the core 1. Specifically, there is a gap 144,44 between a portion of the surface area of respective surfaces of adjacent magnetic bricks that are facing one another. These gaps 144,44 ensure that when the gaps increase in sized (due to, for example, heating of the potting compound 15 which may surround the magnetic bricks 3 (and/or surround core support 13), and/or due to mechanical bending of the antenna 10) the magnitude of change in the effective permeability of the core 1 will be less than the magnitude of change in the permeability of the core 1 that would occur if there were initially no gaps between the magnetic bricks 3. Consequently, the core 1 will have less variance in its inductance, leading to improved and more stable performance of the antenna 10. Also, the convex profile of the longitudinal surfaces 3a,3c and/or the convex profile of the end surfaces 4a,4b allow for more regular spacing between the magnetic bricks 3 that make up the core 1, this in turn leads to less variation in the inductance of the core of the antenna. The magnetic bricks 3 can be arranged to abut one another and because of the convex surface there will still be a gap between a portion of the surfaces belonging to the adjacent magnetic bricks 3 that abut one another; if the magnetic bricks 3 are arranged to abut one another in a regular/reoccurring pattern then this in turn leads to regular/reoccurring gaps/spacing in the core 1 thereby leading to less variation in the inductance of the core 1 of the antenna 10. Moreover, regular/reoccurring gaps/spacing between the magnetic bricks 3 allows for less variation in the inductance of cores of antenna of the same type.

It should be understood that in the present application where there is a ‘gap’ between surfaces this can mean that the surfaces do not touch/abut each other over the whole of their respective surface areas; or, that the surfaces do not touch/abut each other over only part/a portion of the their respective surfaces areas (i.e. that a portion of surfaces touch/abut each other over only a part of their respective surface areas (e.g. at an apex) and do not touch/abut each other the rest of their respective surface areas).

The coil 12 is wound around the core support 13. The winding direction of the coil 12 is in the longitudinal direction 17. The coil 12 preferably has a plurality of turns around the core support 13, preferably with more than two, preferably with more than five, preferably with more than ten, preferably with more than fifteen, preferably with more than twenty turns. The coil 12 preferably extends from the first end of the core 1 to the second end of the core 1, so that the region between the last turn of the coil 12 in the direction of the first end of the core 1 and the last turn of the coil 2 in the direction of the second end of the core 1 makes up at least 70%, preferably at least 75%, preferably at least 80%, of the longitudinal extent of the core 1. The coil 12 preferably extends over an amount of the coil support so that the coil 12 extends over all of the magnetic bricks 3 that are held in the core support 13. The coil 12 windings may apply a compression force to the core support 13 which in turn causes the core support 13 to compress and to clamp the magnetic brick 3 inside the core support 13 thereby helping to restrict movement of the magnetic bricks 3 inside the core support 13.

The coil 12 is preferably wound onto the core support 13, however, it is also possible to wind the coil 2 directly onto the core 1 (without a core support 13). The coil 12 preferably comprises a coil wire 12. The coil wire 12 is preferably insulated. The coil wire 12 is preferably wound such that both ends of the coil wire 12 are connected at one end of the core 1 to terminals of the antenna. In the exemplary embodiment shown, the coil 12 is wound in a direction from the first end of the core 1 to the second end of the core 1 and the core wire 12 is then returned from the second end of the core 1 to the first end of the core 1 (without turns around the core 1). However, it would also be possible first to lead the coil wire 12 from the first end of the core 1 to the second end of the core 1 (without turns around the core 1) and then to wind it in a direction from the second end of the core 1 to the first end of the core 1. It is also possible to wind the coil wire 12 in both directions (cross winding).

The core support 13 preferably further comprises an electrical connector. The coil is connected to the electrical connector of the core support 13. The connector could also form the cap which closes the opening housing 14 when the core support 13 is inserted into the housing 14. The core support 13 is designed to support/hold the core 1. This is especially important for the fitting of the antenna before potting, so that all of the antenna parts are held in the correct position before the antenna is potted. The core support 13 is preferably designed to support the coil 12. The core support 13 preferably has an outer surface, on which the coil 12 is wound.

A potting compound 15 is arranged between the housing 14 and the core support 13 with the coil 12 and containing the core 1. The core support 13 with the coil 12 and containing the core 1 is inserted into the housing 14 and potted therein with the potting compound 15. The potting compound 15 is also often referred to as potting. The potting compound 15 preferably fills at least some of (in some case all of) any remaining empty regions within the housing 14, so that the heat is effectively dissipated from the core 1 and the coil 12, and the core support 13 with the core 1 and the coil 12 is stably mounted; the potting compound 15 will also provide damping of socks applied to the antenna. Preferable the potting compound 15 is a potting compound 15 which (in the cured state) is softer than 60 Shore A, more preferably softer than 40 Shore A, more preferably softer than 35 Shore A, more preferably softer than 30 Shore A, more preferably softer than 27 Shore A, more preferably softer than 25 Shore A. It has been found that the potting compound 15 softer than 60 Shore A or softer than the other preferred values mentioned, not only improves the rupture stability, but surprisingly also improves the stability of the electrical values of the antenna 10. Preferably, however, the potting compound 15 (in the cured state) is harder than 10 Shore A, more preferably is harder than 15 Shore A. The potting compound 15 with a hardness between 10 and 35 Shore A has been found to be particularly advantageous.

According to a further aspect of the present invention there is provided method of manufacturing any one of the above-mentioned antenna embodiments. The method comprises the steps of (a) providing a core support 13;
(b) arranging a plurality of magnetic bricks 3, wherein each of the magnetic bricks 3 have a convex surface, into the core support 13, wherein said plurality of magnetic bricks define the core 1 of the antenna 100;
   (c) winding a coil 12 around the coil support 13;
(d) providing a housing 14;
(e) providing a potting compound inside the housing; (f) inserting the core support 13, which contains said plurality of magnetic bricks 3 and coil 12 wound around it, into the potting compound that is inside the housing 14.

In another embodiment the core support 13, which contains said plurality of magnetic bricks 3 and coil 12 wound around it, is first inserted into the housing 14; and only after the core support 13 has been inserted into the housing is the potting compound then provided inside the housing 14.

It should be understood that a foam compound may be used instead of a potting compound.

Preferably, the core support 13 with the core 1 and the coil 12 is potted in the housing 14 with the potting compound 15. Preferably, after that, the potting compound 15 cures.

The core support 13 preferably further comprises an electrical connector. The method preferably further comprises the step of electrically connecting the coil to the electrical connector. For example the coil may be electrically connected to electrically conductive pins of the connector.

In a preferred embodiment the core support may be tubular (e.g. rectangular tubular) having a first end and a second, opposite end, wherein the first end is open and the second end is closed. In this case the step of arranging a plurality of magnetic bricks into a core support may comprise inserting the bricks into the open first end. Once inserted the magnetic bricks may slide, under the influence of gravity in a direction towards the second end. The magnetic bricks may be arranged in a first series 103a and second series 103a as shown in FIG. 1b. Magnetic bricks 3 may be provided into the core support until the volume inside the core support is substantially filled with the magnetic bricks.

The method preferably further comprises, arranging the plurality of magnetic bricks 3 into the core support 13 so that they compress at least some of the inner spring members 30. The force which the compressed spring members 30 apply to the magnetic bricks 3 help to prevent movement of the magnetic brick 3 within the core support 13. Furthermore, the inner spring members 30 can also reduce inertia of the magnetic bricks 3 when a mechanical shock is imparted on the antenna 10.

Preferably the step of arranging the plurality of magnetic bricks 3 into the core support 13, comprises arranging the magnetic bricks so that the convex surface of each magnetic brick abuts a surface of an adjacent magnetic brick so that there is a gap between a portion of the surface area of the convex surface and the surface of the adjacent magnetic brick that the convex surface abuts.

Most preferably the step of arranging the plurality of magnetic bricks 3 into the core support 13, comprises: arranging some of the magnetic bricks 3 one behind the other in a direction of a longitudinal axis 17a to form a first series 103a of magnetic bricks, and arranging some of the magnetic bricks 3 one behind the other in a direction of a longitudinal axis 17a to form a second series 103b of magnetic bricks, such that there are respective gap 44, 144 between surfaces 3a,3b,3c,3d,4a,4b of adjacent magnetic brick 3.

In a preferred embodiment the method comprises arranging the magnetic bricks in the first and second series so that the apex 3c′ of a longitudinal surface, 3c of magnetic bricks 3 in the first series 103a is offset from a gap 44 between end surfaces 4a,4b of adjacent magnetic bricks 3 in the second series 103b; and so that the apex 3a′ of a longitudinal surface 3a of magnetic bricks 3 in the second series 103b is offset from a gap 44 between end surfaces 4a,4b of adjacent magnetic bricks 3 in the first series 103a.

In an embodiment the step of arranging the plurality of magnetic bricks 3 into the core support 13, comprises arranging the magnetic bricks so that, the longitudinal surface 3a,3b,3c,3d of each magnetic brick 3 in the first series 103a (expect for the first and last magnetic brick 3 in the first series) is opposite and adjacent to (e.g. extends over) 30% of the length ‘L’ of one magnetic brick 3 in the second series 103b and also is opposite and adjacent to (e.g. extends over) 70% of a length ‘L’ of another magnetic brick 3 in the second series 103b (In the present exemplary embodiment since the first series 103a is longer than the second series 103b (i.e. there are more magnetic bricks 3 in the first series 103a than in the second series 103b) the first magnetic brick 3 in the first series 103a is opposite and adjacent to (e.g. extends over) only 30% of the length of one magnetic brick 3 in the second series 103b; and the last magnetic brick 3 in the first series 103a is opposite and adjacent to (e.g. extends over) only 70% of the length of one magnetic brick 3 in the second series 103b); and each magnetic brick 3 in the second series 103b is opposite and adjacent to (e.g. extends over) 30% of the length ‘L’ of one magnetic brick 3 in the first series 103a and also is opposite and adjacent to (e.g. extends over) 70% of a length ‘L’ of another magnetic brick 3 in the first series 103a. This means that for each magnetic brick 3 in the first series 103a (expect for the first and/or last magnetic brick 3 in the first series) the apex 3c′ of the convex longitudinal surface 3c of the magnetic brick 3 will be aligned with a point which is located at 20% along the length ‘L’ of a magnetic brick 3 in the second series 103b; and for each magnetic brick 3 in the second series 103b the apex 3a′ of the convex longitudinal surface 3a of the magnetic brick 3 will be aligned with a point which is located at 20% along the length ‘L’ of a magnetic brick 3 in the first series 103a.

Most preferably a width of the volume defined in the housing 14 will be less than the width that the outer spring members 21,21a,21b span; consequently, when the core support 13 is inserted into the housing 14 the outer spring members 21,21a,21b will be compressed by the inner surface of the housing 14. The compressed outer spring members 21,21a,21b will reduce the amount which the core support 13 will move within the housing 14. The outer spring members 21,21a,21b will also provide some suspension and/or damping to the core support 13 so that when a mechanical shock is imparted on the antenna the spring members will absorb some of the energy of the shock thereby protecting the other components inside the housing 14 (such as the core 1 and core support 13) from damage.

The antenna 10 described herein is preferably designed for use in a vehicle, for the transmission of key data for opening and/or starting the vehicle. This antenna 10 is preferably fitted in a vehicle.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

1. An antenna comprising a core, and a coil, wherein the core comprises a plurality of magnetic bricks, characterized in that each of the magnetic bricks have at least one convex surface.

2. An antenna according to claim 1 wherein the convex surface of each magnetic brick is arranged to abut a surface of an adjacent magnetic brick so that there is a gap between a portion of the surface area of the convex surface and a portion of the surface of the adjacent magnetic brick that said convex surface abuts.

3. An antenna according to claim 2 wherein an apex of the convex surface of each magnetic brick is arranged to abut the surface of an adjacent magnetic brick.

4. An antenna according to claim 2 wherein said surface of the adjacent magnetic brick is convex.

5. An antenna according to claim 1 wherein the core comprises at least, a first series of magnetic bricks which are arranged one behind the other in a direction of a longitudinal axis of the core, and a second series of magnetic bricks which are arranged one behind the other in a direction of a longitudinal axis of the core;
and wherein the first and second series are adjacent to one another so that magnetic bricks in the first series abut magnetic bricks in the second series.

6. An antenna according to claim 5, wherein magnetic bricks are arranged so an apex of the convex surface of each respective magnetic brick in the first series is offset from a gap between end surfaces of adjacent magnetic bricks in the second series; and an apex of the convex surface of each respective magnetic brick in the second series is offset from a gap between end surfaces of adjacent magnetic bricks in the first series.

7. An antenna according to claim 1 wherein each of the magnetic bricks is substantially barrel shaped, comprising at least two opposing longitudinal surfaces each of which are convex.

8. An antenna according to claim 1 wherein each of the magnetic bricks comprise a first end surface and a second, opposite end surface, each of which are convex.

9. An antenna according to claim 1 wherein the assembly further comprises a core support, wherein said plurality of magnetic bricks are positioned in a volume that is defined by said core support.

10. An antenna according to claim 9 wherein the coil is wound around said core support.

11. An antenna according to claim 9 wherein the core support further comprises inner spring members which project into a volume defined by the core support, wherein the spring members apply a force to the magnetic bricks that are located in said volume defined by the core support.

12. An antenna according to claim 9 wherein the core support further comprises outer spring members which project from an outer surface of the core support.

13. An antenna according to claim 9, wherein the antenna further comprises a housing; and wherein the core support containing the plurality of magnetic bricks inside a volume defined by the core support and the coil wound around the core support, is positioned inside a volume defined by the housing; and wherein the antenna further comprises a foam compound and/or potting compound inside said volume defined by the housing which fills a space that is between the core support and an inner surface of the housing.

14. A vehicle having an antenna according to claim 1, the antenna being configured for the transmission of key data for opening and/or starting the vehicle.

15. A method of manufacturing an antenna according to claim 1, the method comprises the steps of
(a) providing a core support;
(b) arranging a plurality of magnetic bricks, wherein each of the magnetic bricks have a convex surface, into a volume define by the core support, wherein said plurality of magnetic bricks define the core of the antenna;
(c) winding a coil around the coil support;
(d) providing a housing;
(e) providing a potting compound inside the housing; and
(f) inserting the core support, which contains said plurality of magnetic bricks and coil wound around it, into the potting compound inside housing.
